(19) United States
(12) Patent Application Publication
(10) Pub. No.: US 2013/0284339 A1
(43) Pub. Date: Oct. 31, 2013

(54) Ballistic Protection Systems and Methods

(71) Applicant: WestWind Technologies, Inc., Huntsville, AL (US)

(72) Inventors: Mark Raymond Cellarius, Madison, AL (US); Danny Bouldin, Athens, AL (US)

(21) Appl. No.: 13/926,843

(22) Filed: Jun. 25, 2013

Related U.S. Application Data
(63) Continuation of application No. 13/035,195, filed on Feb. 25, 2011.

(51) Int. Cl. B64F 5/00

(52) U.S. Cl. CPC B64F 5/0009
USPC 156/60

(57) ABSTRACT

Embodiments of the present disclosure generally pertain to lightweight, environmentally durable, structurally rigid ballistic protection methods. An exemplary method of fabricating the ballistic protection system comprises the steps of assembling the sections separately and curing each section at a specific temperature and pressure. Once the sections are individually assembled and cured, the sections are joined together and cured at a separate temperature and pressure.

### CROSS REFERENCE TO RELATED APPLICATION

This application claims priority to U.S. provisional patent application no. 61/308,373, entitled “Ballistic Protection Systems and Methods” and filed on Feb. 26, 2010 and to U.S. patent application Ser. No. 13/035,195, entitled “Ballistic Protection Systems and Methods” and filed on Feb. 25, 2011, each of which is incorporated herein by reference in its entirety.

### RELATED ART

Ballistic protection systems are used in a wide variety of applications, particularly to protect against enemy fire in military combat applications. One such military combat application is ballistic protection for aerial vehicles, such as helicopters and airplanes. Ballistic protection systems for aerial vehicles should be lightweight in order to enhance aircraft performance while also providing sufficient ballistic protection for the crew and the equipment. Current ballistic protection systems for aerial vehicles typically sacrifice a considerable amount of ballistic protection in order to keep the payload of the vehicle within a desired range. Furthermore, some ballistic protection systems delaminate when exposed to environmental elements such as liquids, cleaning solvents or jet fuel. Thus, a lightweight, environmentally durable ballistic protection system conducive to providing optimal ballistic protection to aerial vehicles without significantly impairing aircraft performance is desirable.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a side view of an exemplary ballistic protection system comprising at least one ballistic protection panel mounted to a vehicle.

FIG. 2 is a top view of a ballistic protection panel, such as is depicted by FIG. 1.

FIG. 3 is a top view of tiles of the panel of FIG. 2.

FIG. 4 is a cross-sectional view of the panel of FIG. 2.

FIG. 5 is a top view of the tiles of the panel of FIG. 4.

FIG. 6 is a top view of a hexagonal honeycomb shield of the panel of FIG. 4.

FIG. 7 is a cross-sectional view of another embodiment of an exemplary ballistic protection system.

FIG. 8 is a block diagram illustrating an exemplary method of assembling a ballistic protection system.

### DETAILED DESCRIPTION

Embodiments of the present disclosure generally pertain to lightweight, environmentally durable, structurally rigid ballistic protection systems and methods. An exemplary embodiment of a ballistic protection system comprises at least one ballistic protection panel mounted to an aerial vehicle. Each panel comprises a bottom section having hard tiles layered with plies of flame retardant and/or other material, a middle section comprising a hexagonal honeycomb shield, and an application-specific top section. Notably, the number of plies of material, the types of material, the size of the honeycomb cells, and the shape of the tiles and panels may be varied to meet application-specific goals. An exemplary method of fabricating the ballistic protection system comprises the steps of assembling the sections separately and curing each section at a specific temperature and pressure. Once the sections are individually assembled and cured, the sections are joined together and cured at a separate temperature and pressure.

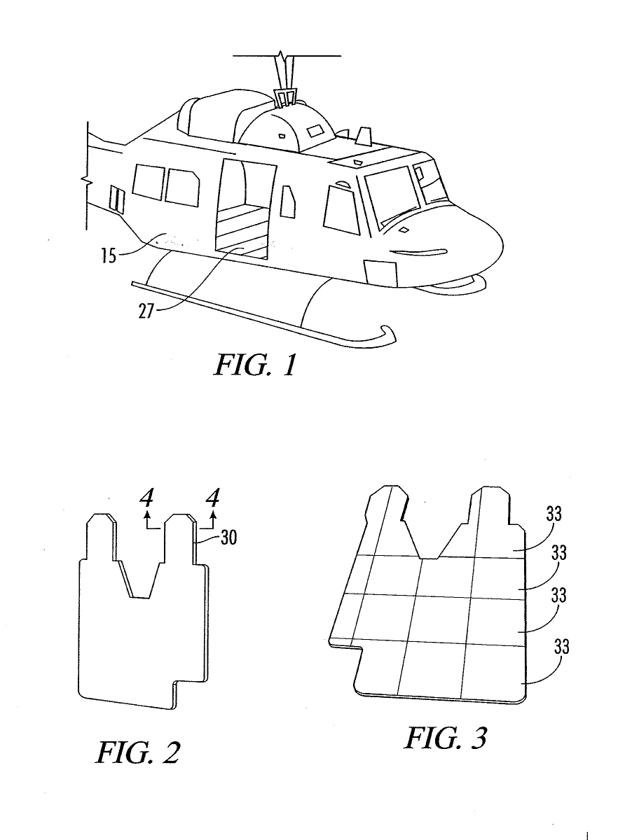

FIG. 1 depicts an exemplary ballistic protection system 10 according to an aspect of the present disclosure. In one embodiment, the exemplary ballistic protection system 10 comprises an aerial vehicle 15, such as a helicopter or airplane, having one or more ballistic Protection panels 27 mounted thereto. The exemplary embodiment shown by FIG. 1 has panels 27 mounted to the floor of the vehicle 15. In such configuration, the panels 27 may prevent ballistic projectiles from entering the vehicle 15 and injuring the vehicle's crew or damaging the vehicle's equipment. Notably, the panels 27 may be mounted to any surface of the aerial vehicle 15 where ballistic protection is desired.

FIG. 2 depicts a top view of an exemplary ballistic protection panel 27. The panel 27 comprises an outer covering 30. In one embodiment, the outer covering 30 comprises flame retardant MB-117 E-glass (“E-glass”), but other material for the covering 30 is possible in other embodiments. The panel 27 may be mounted to any surface of the aerial vehicle 15 in order to prevent ballistic projectiles from entering the vehicle 15. The panel 27 may be shaped to provide application-specific ballistic protection for areas of the vehicle 15 such as the floor, wall, roof, cockpit or other areas that may be vulnerable to penetration by projectiles. The panel 27 may also be fabricated with application-specific mounting holes, integrated cargo tie-down hardware, portal or window openings, or crew equipment such as seating, rollers, or litter mountings. In the present embodiment, the panel 27 is shaped to provide ballistic protection for the floor of the cockpit of the aerial vehicle 15.

The panel 27 provides ballistic protection while also providing noise suppression, structural capabilities, and environmental durability. The noise suppression property of the panel 27 helps to prevent fatigue on the crew of the vehicle 15 due to noise created by the rotor of the vehicle 15. Also, the structural capabilities of the panel 27 allow the panel to be used as a structural member of the vehicle 15, such as a floor or wall, such that equipment may be safely and securely mounted to the panel 27. Furthermore, the panel 27 is environmentally durable such that it may be exposed to environmental elements such as liquids, cleaning solvents, or jet fuel without delaminating or losing any ballistic protection or structural function.

FIG. 3 depicts the panel 27 with the outer covering 30 removed for illustrative purposes to show tiles 33 that are embedded within the outer covering 30. While several tiles 33 shown in FIG. 3 are square, each tile 33 may alternatively be other shapes, such as, for example, hexagonal, rectangular, or irregular. In one embodiment, the tiles 33 are composed of silicon carbide. Notably, silicon carbide is an extremely hard substance which is effective in ballistic protection. The silicon carbide tiles 33 act as a strike plate for the panel 27 by removing the energy from projectiles which come into contact with the panel 27. Silicon carbide is also cost efficient and relatively lightweight (approximately ten percent heavier than aluminum), making it an optimal strike plate substance based on the combination of cost, weight, and ballistic protection. Furthermore, the silicon carbide tiles 33 provide fire protection and a heat barrier for the vehicle 15. While the present embodiment discloses silicon carbide tiles 33, other materials may be used for the tiles 33 without departing from the scope of the present disclosure.

The tiles 33 may be cut and arranged to any desired size and shape according to application specifications. For example, the tiles 33 shown in FIG. 3 are cut and arranged to fit the shape of the cockpit floor of the aerial vehicle 15 (FIG. 1). The tiles 33 are coupled together by applying a bonding material to the tiles 33. The tiles are then wrapped in Polystrand ThermoBallistic S-glass 8015x (“Polystrand 8015x”) with a polypropylene resin/matrix. Although the tiles 33 of FIG. 3 are arranged to the shape of a cockpit floor, other tile arrangements for panels 27 may be utilized depending on the application, such as, for example, door panels, ceiling panels, and wall panels. Also, the thickness of the tiles 33 may be varied to meet application-specific ballistic and fire specifications. Furthermore, the tiles 33 may also provide application-specific mounting holes, troughs, channels, or other desired features for mounting equipment or objects to the panel 27 or mounting the panel 27 to the vehicle 15 or to other panels 27.

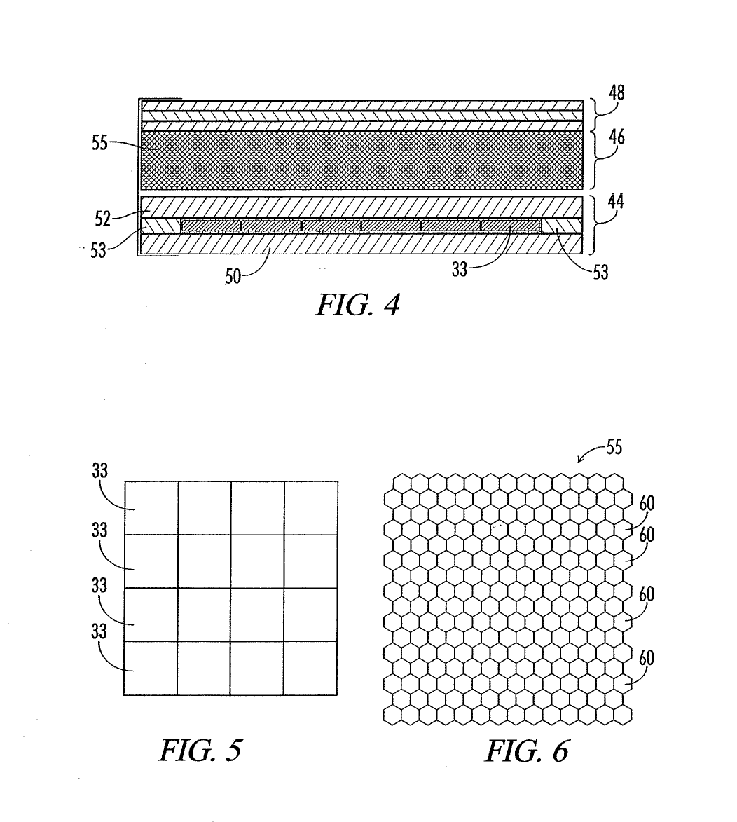

FIG. 4 depicts a cross-sectional view of the panel 27 of FIG. 2. The panel 27 comprises a bottom section 44, a middle section 46, and a top section 48. The bottom section 44 of the panel 27 comprises the tiles 33 positioned between a lower layer 50 and an upper layer 52 of material. The layers 50, 52 comprise plies of material laid upon one another. The types of material chosen and number of plies for the lower layer 50 and the upper layer 52 may vary based on application specifications, such as desired levels of ballistic protection or structural integrity.

In one embodiment, the lower layer 50 comprises a single ply of flame retardant E-glass with multiple plies of pre-impregnated thermoplastic material, such as Polystrand TBA8510 tape or T-Flex-H, stacked on top of the E-glass. The tiles 33 are centered upon the lower layer 50. Multiple plies of material, such as Polystrand 8015x, are layered on top of the lower layer 50 in the margins 53 around the tiles 33. A sufficient number of plies of Polystrand 8015x are used in the margins 53 to at least equal the thickness of the tiles 33. The upper layer 52 is stacked on top of the tiles 33, and generally comprises plies of material organized in a reverse order from the plies of the lower layer 52. For example, if the bottoms of the tiles 33 abut a ply of T-Flex-H material of the lower layer 50, the tops of the tiles 33 will typically abut a ply of T-Flex-H material of the upper layer 52. However, the final plies of material at the top of the upper layer 52 typically comprise a para-aramid synthetic fiber, such as DuPont Kevlar® 49 style 5285, for structural strengthening rather than the E-glass of the lower layer 50. As set forth above, the number and types of materials comprising the upper 52 and lower 50 layers may vary based on application-specific goals.

Once the bottom section 44 is assembled, it is cured by itself at a specific temperature and pressure. The cure time may vary depending on the number and types of materials used. Typically, the thermoplastic materials in the bottom section 44 and the top section 48 cure at relatively high temperatures and pressures compared to the materials in the middle section 46, discussed hereafter. In one embodiment, the bottom section 44 is cured at a temperature of approximately 350 degrees Fahrenheit and a pressure of approximately 150 pounds per square inch (psi).

The middle section 46 of the ballistic protection panel 27 comprises a honeycomb panel 55 having hexagonal-shaped cells. The thickness and cell diameter of the hexagonal honeycomb panel 55 may vary based on application-specific goals. In one embodiment, the honeycomb panel 55 comprises H8PP polypropylene material, but other materials may be used in other embodiments. The polypropylene material of the honeycomb panel 55 is cured at a much lower temperature and pressure than the bottom top sections 44, 48 due to the lower melting point of the polypropylene material. Notably, the polypropylene material of the honeycomb panel 55, discussed in more detail hereafter, provides the properties of noise suppression as well as structural integrity to the panel 27. The middle section 46 is bonded to the bottom section 44 and the top section 48 with a structural film adhesive.

The top section 48 of the panel 27 may also vary based on application-specific goals. In one embodiment, the top section 48 comprises multiple plies of pre-impregnated material, such as S-2 UD tape, and/or multiple plies of thermoplastic material covered with a final ply of flame retardant material. In one embodiment, the final ply of material comprises E-glass. Such embodiment allows the top section 48 to catch fragments of projectiles which are broken by the bottom section 44. In another embodiment, the top section 48 comprises tiles 33 layered with plies of material identical or similar to the bottom section 44. However, the number and types of materials used in the top section 48 may vary in order to produce a desirable combination of ballistic protection, weight, and structural integrity. The top section 48 is typically cured at the same temperature and pressure as the bottom section 44, but the cure time varies based on the number and types of materials used.

Another benefit of the panel 27 is that it provides ballistic protection and structural integrity while remaining relatively lightweight. For example, a one inch thick square foot of steel weighs approximately forty pounds. In one embodiment, a one inch thick square foot of the panel 27 weighs approximately twenty-two pounds. Thus, the panel 27 provides significant weight reduction over typical alternatives. Such weight reduction is desirable in most applications, especially in aerial vehicle 15 applications.

FIG. 5 depicts tiles 33 arranged in a square configuration. The tiles 33 of FIG. 5 are identical to the tiles 33 of FIG. 3 but are arranged in a different manner. In one embodiment, depicted in FIG. 5, the tiles 33 comprise four-inch by four-inch squares of silicon carbide. The tiles 33 may vary in thickness depending on the particular application, such as the type of ballistic threat that is anticipated. The tiles 33 are bonded together with a bonding material before being layered with plies of material. Notably, in other embodiments, the tiles 33 may be rectangular or hexagonal in shape to accommodate specific applications. For example, hexagonal tiles 33 may be used to allow more gradual curves along the edges of the panel 27, but square or rectangular tiles 33 may be used if the panel 27 has edges with sharper angles. Other shapes may be used in yet other embodiments.

FIG. 6 depicts a top view of the hexagonal honeycomb panel 55. The panel 55 has a plurality of hexagonal-shaped cells 60. In one embodiment, the honeycomb panel 55 comprises H8PP polypropylene material. Polypropylene is known for its acoustic noise suppression property in the range of 125 to 150 Hertz (Hz). Additional noise suppression may be achieved by identifying the center frequency of the acoustic vibration range desired to suppress and configuring the diameter of the cell 60 according to the frequency. Higher frequencies require smaller cell diameters. For example, once the cell diameter is set appropriately, the panel 55 absorbs plus or minus 200 Hz of the center frequency selected and dampens plus or minus 1500 Hz of that center frequency. Such noise absorption and dampening is due to the visco-elastic nature of the polypropylene material of the honeycomb panel 55 which eliminates sound and vibration energy created by the noise. Furthermore, the cells 60 of the panel 55 help distribute the energy across the panel 55, further absorbing the acoustic noise. Acoustic noise suppression is desirable because noise from the rotor of the vehicle 15 can cause the crew to become fatigued.

Another function of the honeycomb panel 55 is to provide voids for fragmented projectiles broken apart by the tiles 33. The cells 60 are hollow which provide adequate room for the deposit of projectile fragments. Furthermore, the honeycomb panel 55 provides structural integrity to the ballistic protection panel 27 due to the distribution of weight and energy across the cells 60. For example, when a ballistic projectile strikes the panel 27, the design of the hexagonal honeycomb panel 55 helps distribute energy away from the impact zone. Also, the structural performance or load-bearing capabilities of the panel 55 are not compromised by destruction of a cell 60 or a group of cells 60 due to the hexagonal honeycomb design. Thus, the structural integrity of the panel 55 is not significantly impaired even after the panel 55 is struck with multiple ballistic projectiles.

The polypropylene honeycomb panel 55 may also be formed during the manufacturing process to make gradual curves or sharp angles to accommodate different panel 27 shapes. Such formation is done by heating the panel 55, forming it to the desired shape, and maintaining the desired orientation until the panel 55 cools. As set forth above, the thickness of the panel 55 may vary based on application-specific goals.

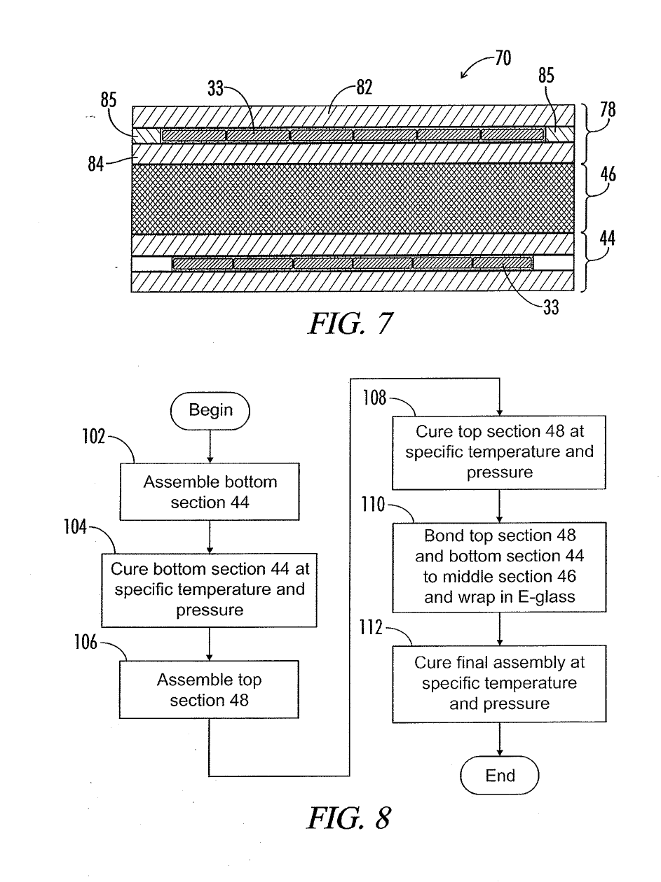

FIG. 7 depicts a cross-sectional view of another exemplary ballistic protection panel 70. Notably, the bottom section 44 and the middle section 46 of the panel 70 remain unchanged from FIG. 4. However, the top section 78 of the panel 70 is assembled similar to the bottom section 44, such that the top section 78 comprises a plurality of tiles 33 positioned between an upper layer 82 and a lower layer 84 of material. Multiple plies of material, such as, for example, Polystrand 8015x, are layered on top of the lower layer 84 in the margins 85 around the tiles 33. A sufficient number of plies of Polystrand 8015x are used in the margins 53 to at least equal the thickness of the tiles 33. By including tiles 33 in both the bottom section 44 and the top section 78, the panel 70 provides ballistic protection in applications where the panel 70 is taking fire from more than one side, such as, for example, shoot houses where the panel 70 is used in a wall between shooters. Notably, the material of the layers 82, 84 may comprise various combinations of E-glass, Polystrand 8015x, Polystrand TBA8510 tape, T-Flex-H®, Kevlar®, or other thermoplastic or thermosetting composite materials depending on application specifications.

In one exemplary embodiment, assume that the bottom section 44 comprises the tiles 33 positioned between a lower layer 50 and an upper layer 52 of material. Also assume that the lower layer 50 comprises multiple plies of T-Flex-H with multiple plies of S-2 glass layered on top. Further assume that the upper layer 52 comprises multiple plies of S-2 glass positioned on top of the tiles 33, with multiple plies of T-Flex-H® layered on top of the S-2 glass and a ply of Kevlar® on top of the T-Flex-H®. Once the bottom section 44 is assembled, as shown by block 102 of FIG. 8, it is then cured at a temperature of 350 degrees Fahrenheit and a pressure of 150 psi, as shown by block 104.

Furthermore, assume that the top section 48 comprises multiple layers of pre-impregnated S-2 UD tape. Once the top section 48 is assembled, as shown by block 106, it is then cured at a temperature of 250 degrees Fahrenheit and a pressure of 100 psi, as shown by block 108. Finally, assume that the middle section 46 comprises the polypropylene hexagonal honeycomb panel 55. The bottom section 44 and the top section 48 are bonded to the middle section 46 with a structural film adhesive, and E-glass is wrapped around all edges, as shown by block 110. Once the sections are assembled and wrapped, they are cured at a temperature of approximately 250 degrees and a pressure of approximately 6 psi under a vacuum, as shown by block 112, forming the panel 27.

1. A method of fabricating a ballistic protection panel, comprising the steps of:
assembling a first section having at least one tile positioned between layers of material;
curing the first section at a specific temperature and pressure;
assembling a second section having at least one ply of material;
curing the second section at a specific temperature and pressure;
bonding the first section and the second section to a third section, the third section comprising a honeycomb panel;
wrapping the first section, the second section, and the third section in an outer covering thereby forming an assembled ballistic protection panel; and
curing the assembled ballistic protection panel at a specific temperature and pressure.

2. The method of claim 1, wherein the at least one tile comprises silicon carbide.

3. The method of claim 1, wherein the honeycomb panel has a plurality of hexagonal-shaped cells.

4. The method of claim 1, wherein the outer covering comprises a flame retardant material.

5. The method of claim 1, further comprising the step of coupling the assembled ballistic protection panel to a surface of an aerial vehicle.
